(19) United States
(12) Patent Application Publication
(10) Pub. No.: US 2026/0159120 A1
(43) Pub. Date: Jun. 11, 2026

(54) VEHICLE CONTROL DEVICE, VEHICLE CONTROL METHOD, AND COMPUTER PROGRAM

(71) Applicant: TOYOTA JIDOSHA KABUSHIKI KAISHA, Toyota-shi (JP)

(72) Inventor: Masakazu NISHIJIMA, Ebina-shi (JP)

(73) Assignee: TOYOTA JIDOSHA KABUSHIKI KAISHA, Toyota-shi (JP)

(21) Appl. No.: 19/181,908

(22) Filed: Apr. 17, 2025

(30) Foreign Application Priority Data
Sep. 13, 2024 (JP) 2024-159233

(51) Int. Cl. B60W 60/00; G06V 20/56; G06V 20/58

(52) U.S. Cl. CPC B60W 60/001; G06V 20/58; G06V 20/588

(57) ABSTRACT

The present disclosure includes a control unit that executes driving assistance of the vehicle, the control unit, the first recognition result of image recognition of the detection region in front of the vehicle, and the second recognition result of the object recognition of the detection region in association with the detection region in the detection region, performs the driving assistance according to the recognition result of the moving body, the detection range of the detection region according to the detection result of the road environment the vehicle travels adjusts the road environment, when it is determined that the road environment is a predetermined road environment in which there is a possibility of erroneously recognizing the moving body, to detect the moving body in the narrow-range detection region narrowed the current detection range, a vehicle control device.

### CROSS-REFERENCE TO RELATED APPLICATION

This application claims priority to Japanese Patent Application No. 2024-159233 filed on Sep. 13, 2024. The disclosure of the above-identified application, including the specification, drawings, and claims, is incorporated by reference herein in its entirety.

### BACKGROUND

### 1. Technical Field

The present disclosure relates to a vehicle control device, a vehicle control method, and a computer program, for executing driving assistance.

### 2. Description of Related Art

In recent years, there has been known a vehicle control device that scans a region forward from a vehicle by radar waves, and executes driving assistance with respect to objects based on detection results of other vehicles or the like, which are objects to be scanned. Vehicles may travel in areas surrounded by walls such as in tunnels, and on roads with noise mitigation baffles, bridges, and the like, in which the vehicle is surrounded by steel. In this case, such vehicle control devices receive radar waves reflected off of structures that are present to the side, such as walls or the like, as noise, and accordingly there is a likelihood that other vehicles that are present in the vicinity of the own vehicle will be erroneously recognized.

Japanese Unexamined Patent Application Publication No. 2005-009914 (JP 2005-009914 A) describes a vehicle control device that lowers detection sensitivity of a radar device when determination is made that the vehicle will travel in a predetermined road environment such as a tunnel, and returns the detection sensitivity of the radar device to an original state when the predetermined road environment ends.

### SUMMARY

According to technology described in JP 2005-009914 A, while the sensitivity of the radar device is lowered in a predetermined road environment, this does not suppress detection of structures that are present to the side of the road, and accordingly there still is the likelihood of erroneously recognizing objects.

An object of the present disclosure is to provide a vehicle control device, a vehicle control method, and a computer program, which are capable of suppressing erroneous recognition of objects in a predetermined road environment, in which there is a likelihood of the objects being erroneously recognized.

An aspect of the present disclosure is a vehicle control device, including
a control unit for executing driving assistance of a vehicle, in which the control unit
detects a moving body that is present in a detection region forward from the vehicle, associating a first recognition result in which image recognition is performed of the detection region, a second recognition result in which physical object recognition is performed of the detection region,
executes the driving assistance in accordance with the recognition results regarding the moving body,
adjusts a detection range of the detection region in accordance with a detection result of a road environment on which the vehicle travels, and
when determination is made that the road environment is a predetermined road environment in which there is a likelihood of erroneously recognizing the moving body, the moving body is detected in a narrow-range detection region in which the detection range as of now is narrowed.

According to the present disclosure, erroneous recognition of objects in a predetermined road environment, where there is a likelihood of erroneous recognition of the objects, can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle control device;

FIG. 2 is a diagram illustrating a detection region of a detecting unit;

FIG. 3 is a diagram illustrating a recognition result of a moving body;

FIG. 4 is a diagram illustrating an example of a predetermined road environment;

FIG. 5 is a diagram illustrating an example of a state in which erroneous recognition of a moving body occurs in a predetermined road environment;

FIG. 6 is a diagram illustrating an example of a state of detecting a predetermined road environment;

FIG. 7 is a diagram illustrating an exemplary narrow-range detection region in a predetermined roadway environment; and

FIG. 8 is a flowchart illustrating a flow of processing of the vehicle control method executed in the vehicle control device.

### DETAILED DESCRIPTION OF EMBODIMENTS

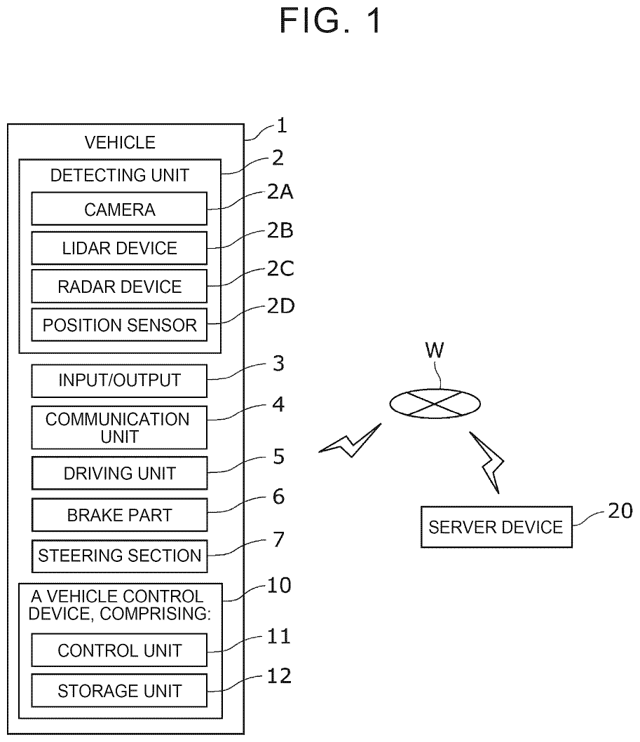

As illustrated in FIG. 1, the vehicle 1 is configured to be capable of executing driving assistance. The vehicle 1 includes a detecting unit 2 and a vehicle control device 10 so as to be capable of executing driving assistance such as ADAS (Advanced Driver-Assistance Systems). The detecting unit 2 detects an environment around the vehicle 1. The detecting unit 2 includes a plurality of devices according to the application. The detection value detected by the detecting unit 2 is used for driving assistance, a navigation device, or the like.

The detecting unit 2 includes a camera 2A that captures an image of the surroundings of the vehicle 1. The camera 2A captures an image of the surroundings of the vehicle 1. In the present embodiment, the camera 2A captures an image of a predetermined area in front of the vehicle 1. Image data of the camera 2A is used, for example, for driving assistance of the vehicle 1 and a drive recorder. The imaging area and the imaging direction of the camera 2A may differ depending on the vehicle 1.

The detecting unit 2 includes a lidar device 2B that detects three-dimensional information about the vehicle 1. The lidar device 2B irradiates the front of the vehicle 1 or the periphery of the vehicle 1 with the laser beam in the detection region at a constant cycle, and measures the reflected light from the object. The lidar device 2B is configured to be able to adjust the detection region. The lidar device 2B scans the laser beam in the detection region to acquire measurement data. The lidar device 2B is configured to generate three-dimensional point cloud data around the vehicle 1 based on the measurement data.

The measured value of the lidar device 2B is used to detect other vehicles present around the vehicle 1, traffic participants such as pedestrians, bicycles, and motorcycles, and objects present around the vehicle 1. The lidar device 2B detects a road structure present in the road environment.

The detecting unit 2 includes, for example, a radar device 2C that scans a radar wave and detects an object existing around the vehicle 1. The radar device 2C is configured to complement the lidar device 2B to detect an object. The radar device 2C emits a millimeter-wave radar wave in a detection region, and receives a reflected wave reflected by the object to detect a relative-distance with respect to the object. The radar device 2C is configured to be able to adjust the detection region.

The measurement of the radar device 2C is used to detect other vehicles present around the vehicle 1, traffic participants such as pedestrians, bicycles, and motorcycles, and objects present around the vehicle 1. The radar device 2C detects a road structure existing in the road environment. The object recognizing unit is constituted by the lidar device 2B and/or the radar device 2C.

The detecting unit 2 includes a position sensor 2D that detects the present position of the vehicle 1. The position sensor 2D is, for example, a GPS (Global Positioning System) sensor or a GNSS (Global Navigation Satellite System) sensor. The position sensor 2D may mutually complement the position of the vehicle 1 by an autonomous sensor (not shown) used for autonomous navigation such as a gyro sensor or an acceleration sensor.

The vehicle 1 includes an input/output unit 3 capable of receiving an operation by a user and displaying information. The input/output unit 3 includes, for example, a touch panel capable of receiving a touch operation and displaying a display image. The input/output unit 3 may be configured individually by an input unit and a display unit. The input unit receives an input operation such as a physical switch. The display unit can display information such as a display device such as an LCD (Liquid Crystal Display) or an organic EL (Electro Luminescence) display. As will be described later, the input/output unit 3 receives a user's manipulation to adjust the detection region of the lidar device 2B and the radar device 2C.

The vehicle 1 includes a communication unit 4 that can be communicatively connected to the network W. The communication unit 4 is a communication interface configured to be capable of wireless communication. For example, the communication unit 4 communicates with a radio base station existing around the vehicle 1, and mutually communicates with various communication targets via the network W. For example, the vehicle 1 communicates with the server device 20 communicatively connected to the network W, and acquires map data including the current position of the vehicle 1.

The vehicle 1 includes a driving unit 5 that generates driving power. The driving unit 5 is constituted by, for example, an internal combustion engine using fuel. The driving unit 5 is constituted by an electric motor when the vehicle 1 is an electrified vehicle. When the vehicle 1 is a hybrid electric vehicle, the driving unit 5 may be configured by combining an internal combustion engine and an electric motor. The driving unit 5 is controlled by the vehicle control device 10 at the time of execution of the driving assistance, and the speed is adjusted.

The vehicle 1 includes a braking unit 6 for reducing the vehicle speed and controlling the vehicle to a stopped state. The braking unit 6 is constituted by, for example, a brake device that generates a braking force. The braking unit 6 may be integrated with the driving unit 5 when the vehicle 1 is an electrified vehicle. The braking unit 6 is controlled by the vehicle control device 10 when driving assistance is executed.

The vehicle 1 includes a steering unit 7 for operating a traveling direction. The steering unit 7 includes a power steering device or the like that provides a steering angle to the steered wheels in response to a steering wheel operation. When the vehicles 1 are electrified vehicle, the steering unit 7 may be integrated with the driving unit 5 that variably controls the left and right driving forces of the driving wheels. The steering unit 7 is controlled by the vehicle control device 10 at the time of executing the driving assistance, and the steering angle is adjusted.

The vehicle control device 10 includes a control unit 11 that executes control related to traveling of the vehicle 1. The control unit 11 integrates and executes control such as traveling, driving assistance, navigation, and communication via the network W of the vehicle 1 based on the detection value detected by the detecting unit 2. The control unit 11 is constituted by a hardware processor such as at least one CPU (Central Processing Unit). The control unit 11 may be realized by hardware (including circuitry; circuitry) such as LSI (Large Scale Integration), ASIC (Application Specific Integrated Circuit), FPGA (Field-Programmable Gate Array), GPU (Graphics Processing Unit), or the like, or may be realized by cooperation of software and hardware.

The vehicle control device 10 includes a storage unit 12 that stores data and programs. The storage unit 12 includes a non-transitory storage medium such as a hard disk drive (HDD) or a solid state disk (SSD). The storage unit 12 stores computer programs and data necessary for controlling the vehicle 1. The program may be stored in the storage unit 12 in advance, or may be stored in an externally connectable storage medium such as a DVD or a CD-ROM, and may be installed in the storage unit 12 when the storage medium is mounted in the drive device. The control unit 11 controls the driving unit 5, the braking unit 6, and the steering unit 7 based on the detection values detected by the detecting unit 2, and executes driving assistance control such as obstacle pre-read assist (Obstacle Anticipation Assist: OAA).

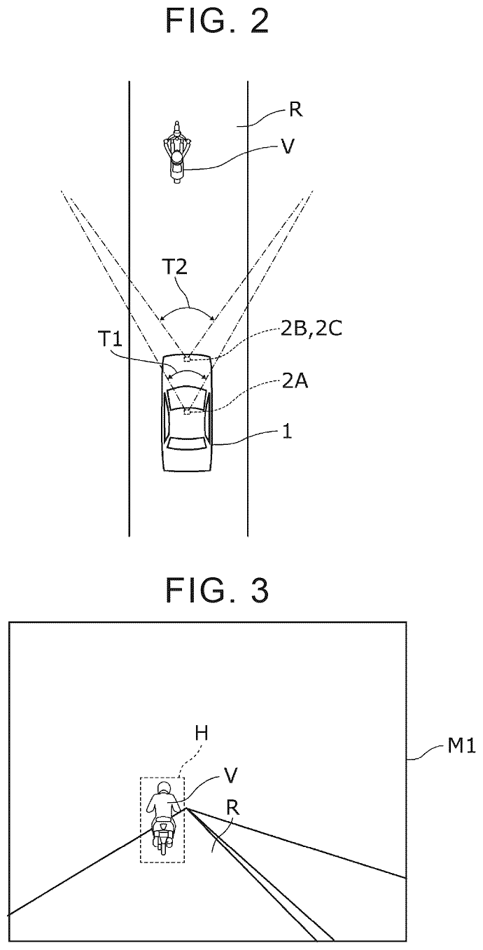

As illustrated in FIG. 2, the vehicle 1 detects a moving body V such as a traffic participant in a lane R of a traveling road, and executes driving assistance by the vehicle control device 10. In the vehicle control device 10, the control unit 11 performs image recognition of the detection region T1 in front of the vehicle 1 based on the captured image of the camera 2A. The detection range of the detection region T1 is set in accordance with the imaging range of the camera 2A. The control unit 11 performs image recognition of the moving body V of the preceding other vehicle or the like as a driving assistance object based on the first recognition result obtained by recognizing the detection region T1 in front of the vehicle 1.

As illustrated in FIG. 3, the control unit 11 recognizes an object moving in the captured image M1 based on the first recognition result. The control unit 11 compares a plurality of captured images for each frame, and recognizes, as a background, a pixel group that moves entirely within the image. For example, the control unit 11 compares a plurality of captured images for each frame, and extracts, as an object, a pixel group that moves in the same direction relative to the background in the image. The control unit 11 calculates an estimated value such as an assumed position, a relative movement direction, and a relative speed of an object moving in the image.

The control unit 11 recognizes the detection region T2 based on the lidar device 2B and/or the detection value detected by the radar device 2C. The detection region T2 is set to a region substantially coinciding with the detection region T1 in the normal condition. Based on the second recognition result, the control unit 11 calculates an estimated value regarding the object, such as a relative position, a relative moving speed, a relative moving direction, and the like, of the object moving in the detection region T2.

The control unit 11 executes a process of associating the first recognition result obtained by image recognition the detection region T1 in front of the vehicle 1 with the second recognition result obtained by object-recognizing the detection region T2. The control unit 11 associates an object existing in the detection region T1 with an object existing in the detection region T2, and detects the moving body V existing in the detection region T1, T2. For example, the control unit 11 determines whether an error between the estimated value based on the first recognition result and the estimated value based on the second recognition result is equal to or less than a preset criterion.

When the error between the estimated value based on the first recognition result and the estimated value based on the second recognition result is equal to or less than a preset reference, the control unit 11 determines that the object existing in the detection region T1 and the object existing in the detection region T2 are the same moving body V. The control unit 11 detects the moving body V existing in the detection region T1, T2 based on the determination result H. The control unit 11 executes the driving assistance according to the recognition result of the moving body V. The control unit 11 recognizes the moving body V extracted by the second recognition result obtained by recognizing the detection region T2 in front of the vehicle 1 as an object for driving assistance. The control unit 11 tracks the detected moving body V as an object for driving assistance.

The control unit 11 calculates the relative distance and the relative speed between the detected moving body V and the vehicle 1. The control unit 11 divides the relative distance by the relative speed to calculate a TTC (Time to Collision) indicating the time until the vehicle 1 collides with the moving body V). The control unit 11 monitors TTC on the moving body V, and executes driving assistance control for causing the input/output unit 3 to output a predetermined notification by sound, images, or the like within a predetermined value indicating the approach of the moving body V set in advance by TTC. The control unit 11 monitors TTC to the moving body V based on the recognition result of the moving body V. The control unit controls the braking unit 6, the driving unit 5, and the steering unit 7 when TTC becomes equal to or less than a preset threshold value for contact with the moving body V, and executes driving assistance control for suppressing contact between the moving body V and the vehicle 1.

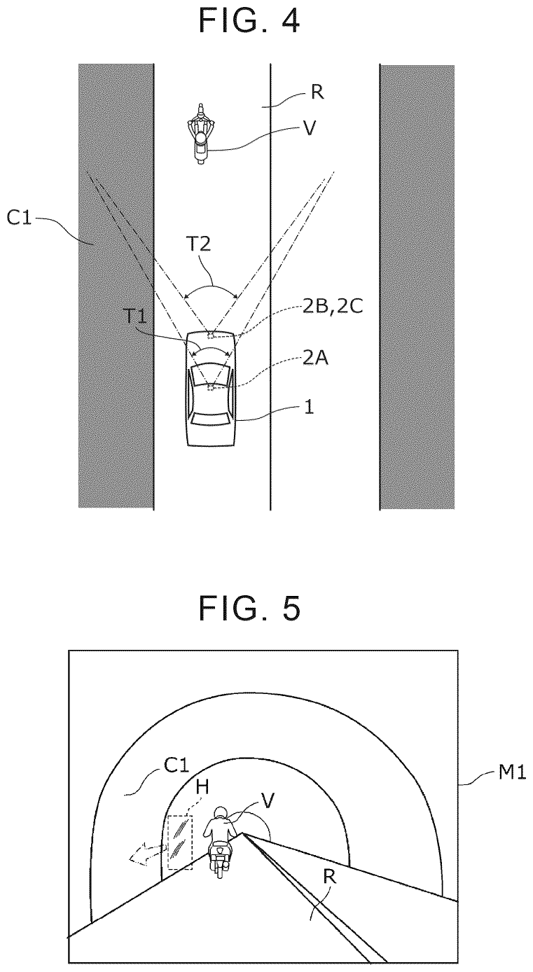

As shown in FIGS. 4 and 5, there may be a road-structure C1 on the side of the lane R on which the vehicle 1 travels. The road structure C1 is, for example, a structure adjacent to and continuously provided on the outer side of the lane R in a road environment classified into attributes such as a side wall of a tunnel, a structural member of a bridge, a retaining wall, a soundproof wall, a guardrail, a steep cliff slope, a tree, and a side wall of an underpass. In this way, in a predetermined road environment in which the road structure C1 is present, the road structure C1 may be included in the detection region T1, T2.

In a predetermined road environment, the detection region T1, T2 may include a road structure C1. In this predetermined road environment, the first recognition result of the road structure C1 existing in the vicinity of the moving body V is associated with the second recognition result of the road structure C1 existing in the vicinity of the moving body V, and there is a possibility that this is calculated as the determination result H of the moving body V. Consequently, when it is recognized that the road-structure C1 existing in the vicinity of the moving body V is the moving body V, the driving assistance is executed, and there is a possibility that the user feels troublesomeness. The vehicle control device 10 is configured to be able to adjust a detection region in the detection regions T1, T2, for example, based on a user's manipulation. The control unit 11 is configured to automatically adjust the detection range of the detection region T1, T2 according to the detection result of the road environment in which the vehicle 1 travels.

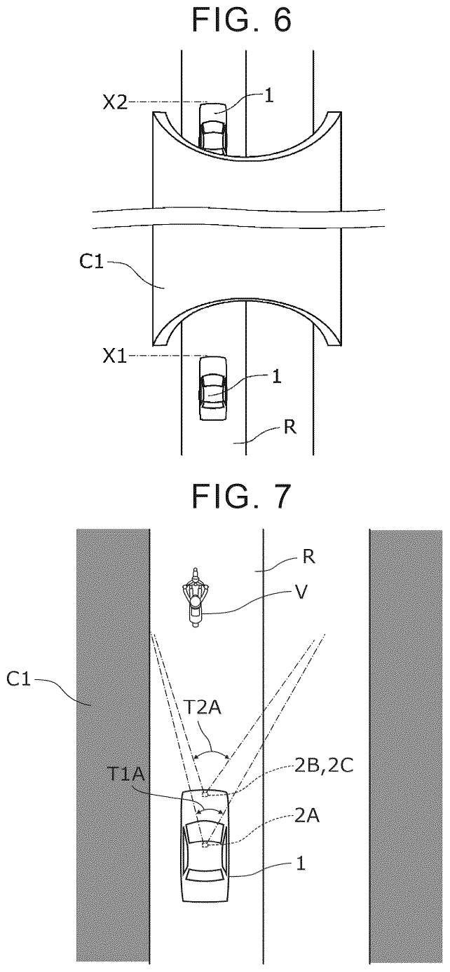

As illustrated in FIG. 6, the control unit 11 determines whether or not to travel in a predetermined road environment in which there is a possibility of erroneously recognizing the moving body V based on the detection value of the current position of the vehicle 1. The control unit 11 acquires the position sensor 2D and the autonomous sensor from the vehicle 1. The control unit 11 acquires map data including the current position stored in the storage unit 12. The control unit 11 may acquire map data from the server device 20.

The control unit 11 performs route search based on the map data, and determines the attribute of the lane R on which the vehicle 1 travels. The control unit 11 determines whether or not the predetermined road environment is included in the lane R based on the determination result of the attribute of the lane R. When determining that there is a possibility of erroneously recognizing the moving body V in the road environment regardless of the map data, the control unit 11 may determine that the lane R is the predetermined road environment. The control unit 11 may determine, based on the recognition result using the captured image, a road construction section that does not exist in the map data, a congested vehicle of an adjacent lane, a road structure, or the like as a predetermined road environment.

When determining that the predetermined road environment is included in the lane R, the control unit 11 calculates, in the lane R, a first point X1 at which the predetermined road environment starts and a second point X2 at which the predetermined road environment ends. When determining that the vehicle 1 has reached the first point X1, the control unit 11 determines that the vehicle 1 travels in a predetermined road environment. For example, in a case where the road environment in which the vehicle 1 travels is recognized as a tunnel or a bridge on the basis of the detection value of the current position of the vehicle 1, the control unit 11 determines that the road environment is a predetermined road environment in which there is a possibility that the moving body is misidentified. The control unit 11 is configured to be able to adjust the detection range of the present detection region T1, T2 in accordance with the detection result of the road environment in which the vehicle 1 travels.

As illustrated in FIG. 7, when it is determined that the detection region is a predetermined road environment, the control unit 11 adjusts the detection region to a narrow-range detection region T1A, T2A in which the detection range is narrower than the present detection region T1, T2. The narrow-range detection region T1A, T2A is set so as to narrow the scanning area of the lidar device 2B and the scanning area of the radar device 2C as compared with the detection region T1, T2, and not to include the road-structure C1 existing outside the lane R.

The control unit 11 is configured to be able to adjust the detection range in at least two stages of a detection region T1, T2 and a narrow-range detection region T1A, T2A. The control unit 11 may be configured to freely adjust the detection range according to the road environment as well as two stages. For example, when it is determined that the road environment in which the vehicle 1 travels is a tunnel or a bridge, the control unit 11 adjusts the present detection region T1, T2 to the narrow-range detection region T1A, T2A so as not to include the road structure C1 provided on the side of the tunnel or the bridge. The detection range of the detection region T1, T2 may be set in two or more stages in order of detection sensitivity. The control unit 11 may adjust the scanning range of the lidar device 2B and the detection sensitivity of the radar device 2C to be the smallest among the plurality of ranges set in a stepwise manner, and/or adjust the scanning range of the lidar device 2B and the scanning range of the radar device 2C to be the smallest set narrow-range detection region T1A, T2A. In this case, for example, in a region other than the narrow-range detection region T1A, T2A, the detection sensitivity to the moving body V is high, and the driving assistance is executed.

The control unit 11 detects the moving body V existing in the detection region by associating the first recognition result obtained by image recognition the detection region in front of the vehicle in the narrow-range detection region T1A with the second recognition result obtained by object recognition in the narrow-range detection region T2A. The control unit 11 calculates a TTC for the moving body V, and executes driving assistance according to the calculated TTC.

Based on the detected value of the present position of the vehicle 1, when it is determined that the vehicle 1 has reached the second point X2, the control unit 11 determines that the predetermined roadway environment has ended. When it is determined that the predetermined road environment has ended, the control unit 11 executes a process of returning the narrow-range detection region T1A, T2A to the original detection region T1, T2. The control unit 11 continuously executes the driving assistance based on the detection region T1, T2 (see FIG. 2). The detection region T1, T2 may be an adjusted area based on a user's manipulation. When determining that the predetermined road environment has ended, the control unit 11 may execute a process of returning the narrow-range detection region T1A, T2A to the adjusted detection region T1, T2 based on the manipulation of the user before the first point X1.

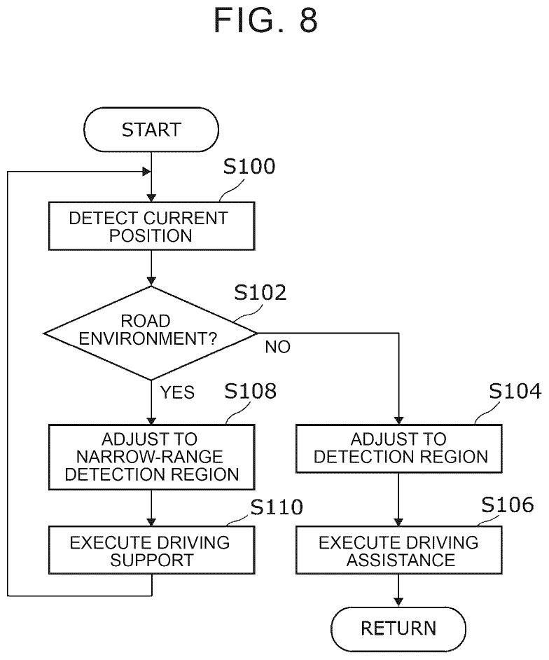

FIG. 8 shows a flow of processing of the vehicle control method executed in the vehicle control device 10. The vehicle control method is executed by a processor mounted in the vehicle control device 10 that executes the driving assistance of the vehicle 1. The computer program installed in the vehicle control device 10 causes the processor to execute the following processing.

The control unit 11 detects the present position of the vehicle 1 by the detecting unit 2 (S100). The control unit 11 searches map data including the current position based on the detected value of the current position of the vehicle 1, and determines whether or not the road environment of the lane R on which the vehicle 1 is traveling is a predetermined road environment (S102). When it is determined that the road environment is not the predetermined road environment (S102: No), the control unit 11 adjusts the detection range of the lidar device 2B and/or the radar device 2C to the detection regions T1 and T2 set by the user (S104).

When the moving body V is recognized in the detection region T1, T2, the control unit 11 executes driving assistance for the moving body V (S106). The process based on the detection region T1, T2 is executed in a predetermined time-range of one cycle. The control unit 11 returns the process to S100 and continues the process. When it is determined in S102 that the road environment is the predetermined road environment (S102: Yes), the control unit 11 adjusts the detection range of the lidar device 2B and/or the radar device 2C to the narrow-range detection regions T1A and T2A (S108). The narrow-range detection region T1A, T2A is narrower than the detection range of the detection region T1, T2.

When recognizing the moving body V in the narrow-range detection region T1A, T2A, the control unit 11 executes driving assistance for the moving body V (S110). The process based on the narrow-range detection region T1A, T2A is executed in a predetermined time-range of one cycle. The control unit 11 returns the process to S100 and continues the process. If the control unit 11 determines that the predetermined road environment has ended in S102 (S102: No), the control unit 11 adjusts the detection range of the lidar device 2B and/or the radar device 2C to the detection regions T1 and T2 (S104), and executes driving assistance (S106).

As described above, according to the vehicle control device 10, when the road environment on which the vehicle 1 travels is a predetermined road environment in which there is a possibility of erroneously recognizing the moving body V, it is possible to adjust the detection range of the lidar device 2B and/or the radar device 2C and reduce erroneous recognition of the moving body V. According to the vehicle control device 10, the detection range of the lidar device 2B and/or the radar device 2C is adjusted to the narrow-range detection regions T1A and T2A narrower than the detection ranges of the detection regions T1 and T2 in a predetermined road environment. Accordingly, it is possible to reduce erroneous recognition of the road-structure C1 existing in the vicinity of the lane R as the moving body V. According to the vehicle control device 10, it is possible to suppress excessive driving assistance in a predetermined road environment and to reduce the user's feeling of troublesomeness.

In the above-described embodiment, the computer program executed in each configuration of the vehicle control device 10 may be provided in a form recorded in a computer-readable portable recording medium such as a semiconductor memory, a magnetic recording medium, or an optical recording medium. The computer program may be provided as a computer product for implementing the vehicle control device 10 and the vehicle control method.

What is claimed is:

1. A vehicle control device, comprising a control unit for executing driving assistance of a vehicle, wherein
the control unit
detects a moving body that is present in a detection region forward from the vehicle, associating a first recognition result in which image recognition is performed of the detection region, a second recognition result in which physical object recognition is performed of the detection region,
executes the driving assistance in accordance with the recognition results regarding the moving body,
adjusts a detection range of the detection region in accordance with a detection result of a road environment on which the vehicle travels, and
when determination is made that the road environment is a predetermined road environment in which there is a likelihood of erroneously recognizing the moving body, the moving body is detected in a narrow-range detection region in which the detection range as of now is narrowed.

2. The vehicle control device according to claim 1, wherein, when determining that the predetermined road environment ended, the control unit returns the narrow-range detection region to the detection region, and continues to execute the driving assistance.

3. The vehicle control device according to claim 1, wherein
the control unit
determines that the road environment is the predetermined road environment when the road environment is recognized as being a tunnel or a bridge, and
adjusts the detection range as of now to the narrow-range detection region so as not to include a road structure provided on a side of the tunnel or the bridge.

4. The vehicle control device according to claim 1, wherein
the control unit
determines that the road environment is the predetermined road environment when the road environment is recognized as being a tunnel or a bridge, and
adjusts the detection range to the narrow-range detection region of which detection sensitivity is smallest, from among a plurality of ranges that is set for the detection range in a stepwise manner in order of the detection sensitivity.

5. A vehicle control method for executing driving assistance of a vehicle, wherein
a computer making up a vehicle control device that is installed in the vehicle
detects a moving body that is present in a detection region forward from the vehicle, associating a first recognition result in which image recognition is performed of the detection region, a second recognition result in which physical object recognition is performed of the detection region,
executes the driving assistance in accordance with the recognition results regarding the moving body,
adjusts a detection range of the detection region in accordance with a detection result of a road environment on which the vehicle travels, and
when determination is made that the road environment is a predetermined road environment in which there is a likelihood of erroneously recognizing the moving body, the moving body is detected in a narrow-range detection region in which the detection range as of now is narrowed.

6. A computer program executed by a processor that is installed in a vehicle control device that executes driving assistance of a vehicle,
the computer program causing the processor to execute processing of
detecting a moving body that is present in a detection region forward from the vehicle, associating a first recognition result in which image recognition is performed of the detection region, a second recognition result in which physical object recognition is performed of the detection region,
executing the driving assistance in accordance with the recognition results regarding the moving body,
adjusting a detection range of the detection region in accordance with a detection result of a road environment on which the vehicle travels, and
when determination is made that the road environment is a predetermined road environment in which there is a likelihood of erroneously recognizing the moving body, the moving body is detected in a narrow-range detection region in which the detection range as of now is narrowed.
